(19) United States
(12) Patent Application Publication
(10) Pub. No.: US 2012/0042758 A1
(43) Pub. Date: Feb. 23, 2012

(54) PORTION FORMING ON MULTITRACK SLICING

(75) Inventor: Günther Weber, Gross Nemerow (DE)

(73) Assignee: WEBER MASCHINENBAU GMBH BREIDENBACH, Breidenbach (DE)

(21) Appl. No.: 13/212,011

(22) Filed: Aug. 17, 2011

(30) Foreign Application Priority Data
Aug. 18, 2010 (DE) 102010034675.6

(51) Int. Cl. B26D 5/20; B26D 7/32; B26D 7/06

(52) U.S. Cl. 83/23; 83/39; 83/401

(57) ABSTRACT

The invention relates to a method for the simultaneous multitrack slicing of a plurality of food products, in particular food products of different types, into respective portions including at least one product slice, wherein the products are sliced using a common slicing apparatus, in particular a high-performance slicer, which has at least one cutting blade which rotates in a cutting plane about a blade axis and/or revolves about a central axis in a planetary motion and in that the products are individually supplied to the cutting blade such that each portion satisfies a condition predefined for the respective track which in particular relates to the weight of the portion, the weight and/or the thickness of the product slices forming the portion and/or the number of the product slices forming the portion.

### CROSS-REFERENCE TO RELATED APPLICATION(S)

This application claims priority from German Patent Application No. DE 10 2010 034 675.6, filed Aug. 18, 2010, entitled “PORTION FORMING ON MULTITRACK SLICING,” which is fully incorporated herein by reference.

### TECHNICAL FIELD

This disclosure relates to the simultaneous slicing of a plurality of food products, including food products of different types into respective portions.

### SUMMARY OF THE INVENTION

Example embodiments relate to a method for the simultaneous multitrack slicing of a plurality of food products, in particular food products of different types into respective portions including at least one product slice. Example embodiments further relate to a method of forming total portions from a plurality of portions, in particular portions disposed at least partly above one another, which each include at least one slice of a food product.

At least one example embodiment furthermore relates to an apparatus, in particular to a high-performance slicer, for the simultaneous multitrack slicing of a plurality of food products, in particular food products of different types, into respective portions including at least one product slice. Example embodiments further relate to a production line having at least one slicing apparatus of the kind described here and having at least one conveying apparatus which can be operated to form total portions in accordance with a method of the kind described here.

The apportioned slicing of food products, also in a multitrack operation, is generally known. Reference is made to EP 0 713 753 B1 for this purpose, for example. The products to be sliced simultaneously can be supplied individually, and indeed with the aim of ensuring as required that the slices cut from a product differ with respect to the thickness of the slices cut from the other product.

Consumers in numerous fields are becoming increasingly more demanding, including purchasers of packed food slices. A plurality of product slices, also called a portion here, should not only have a predefined, desired or required weight and be presented in an appealing manner, but it is rather also increasingly desired that the packages contain slices of different products or of products of different types. For example, different sausage types or of different cheese types may be desired, with it also being desired that sausage slices and cheese slices together form a mixed total portion in the packages.

Such consumer desires can be satisfied in principle using conventional technology. Modern slicing machines, which are also called high-performance slicers, can slice food products extremely fast, with a very precise weight and extremely hygienically. Together with sophisticated conveying technology and packaging machines, such slicers form highly efficient production lines with which packages having portions of food slicers can be produced practically fully automatically. To manufacture “mixed packages” of slicers of different products, a plurality of slicers are used which each slice one kind of product or one product type. The individual product streams of the slicers are then led together in a simple manner to produce the “mixed” total portions. A plurality of slicers is also necessary because there is the consumer desire, which has to be satisfied by the package manufacturers, that the “mixed packages” should not only contain slices of different products, but that moreover a different number of slices of the respective individual products should also be present in the packages.

The ability of known slicers to slice a plurality of products simultaneously cannot eliminate the requirement of a use of a plurality of slicers since the known simultaneous slicing of a plurality of products only increases the product throughput that is the “yield” of the slicer.

The manufacture of the mentioned “mixed packages” is consequently currently associated with relatively high costs.

It is at least one object of the example embodiments to expand the possibilities in the slicing of food products, with it in particular being possible to manufacture “mixed packages” of slices of different food products, in particular of products of different types, as simply, reliably, efficiently and inexpensively as possible.

This object may be satisfied by a slicing method having the claimed features, by a method for forming total portions having the claimed features, by a slicing apparatus having the claimed features as well as by a production line having the claimed features.

In the slicing method, provision is in particular made that the products are sliced using a common slicing apparatus, in particular a high-performance slicer, which has at least one cutting blade that rotates in a cutting plane about a blade axis and/or revolves about a central axis in a planetary motion and in that the products are individually supplied to the cutting blade such that each portion satisfies a condition predefined for the respective track which in particular relates to the weight of the portion, the weight and/or the thickness of the product slices forming the portion and/or the number of the product slices forming the portion.

In accordance with example embodiments, the individual product supply is utilized to give the portions produced in the individual tracks predefined, required or desired properties, in particular mutually different properties, i.e. to achieve that the portions of the individual tracks satisfy conditions which are in particular different and which can be directly predefined.

It is hereby in particular possible to produce those portions with a single slicing apparatus which are required for the formation of a total portion and thus for a “mixed package” desired by the customer.

It is in particular possible with example embodiments to slice food products of different types simultaneously, with it moreover being possible to vary further parameters of the individual portions individually by a corresponding operation of the product supply. For example, total portions can be manufactured in this manner that each include a specific number of slices of a first type of sausage, a specific number of slices different therefrom of a second type of sausage as well as in turn another specific number of slices of a type of cheese.

The production of portions having a different number of slices in the individual tracks can in particular take place in that the slicing apparatus is operated such that so-called blank cuts are carried out directly in the individual tracks, i.e. a blank cut management takes place on an individual track basis. It is provided for the carrying out of a blank cut that no slice is cut from the respective product or products despite a cutting movement carried out by the cutting blade. For example, that product for which a blank cut should be carried out, that is from which no slice should be cut, can be temporarily stopped by a corresponding control of the product supply. The cutting of slices from the other product or products is continued in so doing. In this manner, the aim can be achieved using a product feed which can be operated on an individual track basis of producing portions with different numbers of slices on the simultaneous multitrack slicing of a plurality of products in the tracks.

The products in the tracks can be supplied to the cutting blade completely independently of one another.

It is also possible that the products are supplied to the cutting blade in the tracks such that a plurality of conveying devices, which are arranged in parallel or aligned next to one another, are driven together and the individual speeds of the conveying devices are individually varied.

The term “type” used in part here is to be understood widely. For example, not only sausage, on the one hand, and cheese, on the other hand, or respective different kinds of meat, sausage or cheese of mutually different types should be formed in the sense of the invention. Products with the “same content” which differ from one another with respect to at least one parameter relevant from the view of the end consumer should also be considered as products of different types. For example, salami with a small diameter, on the one hand, and salami with a large diameter, on the other hand, should thus represent different product types in the sense of the example embodiments. In view of the fact that no two food products are identical in a strict sense, the term “type” is, in contrast, not to be understood so widely that differences between products are covered that the end consumer either does not perceive at all or which are completely irrelevant for the end consumer such as different distributions of the density or of the components of a product that are also naturally always present in products which are “the same” from the view of the consumer.

In the method in accordance with example embodiments for forming total portions, the respective portions forming a total portion are produced by the slicing method in accordance with at least one example embodiment.

The total portions can in particular be formed from portions whose slices differ from one another with respect to the product type.

Alternatively or additionally, it is possible that the total portions are formed from portions which differ from one another with respect to the number of their slices, with respect to their portion weight and/or with respect to the weight and/or the thickness of their slices-

The formation of the total portions can, for example, take place during the transport of the portions to a downstream device, in particular to a packaging machine for the total portions.

Provision is in particular made that the total portions are formed in that the portions are placed at least partly above one another.

It is furthermore possible that the total portions are formed in that the portions are introduced into a package after one another, in particular during the transport of the portions to a downstream device, in particular a packaging machine for the total portions. In this respect, a first portion can in particular first be placed into a package, whereupon one or more further portions are placed onto the first portion already located in the package. It is, however, also possible that the complete total portions are first placed into the packages.

Provision is made in an embodiment that, in the formation of the total portions, a separating layer, for example of paper, is placed in each case between at least two portions disposed at least partly above one another.

The slicing apparatus in accordance with the invention includes a product feed which includes a plurality of conveying devices which are arranged in parallel next to one another and with which the products can be supplied in multiple tracks to a cutting plane in which at least one cutting blade moves, in particular in a rotating and/or revolving manner. The product feed is made to supply the products to the cutting blade individually such that each portion satisfies a condition predefined for the respective track which in particular relates to the weight of the portion, the weight and/or the thickness of the product slices forming the portion and/or the number of the product slices forming the portion.

The conveying devices of the product feed can be operable completely independently of one another. Provisions may also be made that the conveying devices can be driven together and the individual speeds of the conveying devices can be individually varied.

In the production line in accordance with example embodiments, which includes at least one slicing apparatus in accordance with the example embodiments and at least one conveying apparatus operable in accordance with the example embodiments, at least one packaging machine for the total portions to be produced can be disposed downstream of the conveying apparatus.

### BRIEF DESCRIPTION OF THE DRAWINGS

Possible embodiments of the invention can also be seen from the dependent claims, from the description and from the drawings. There are shown:

FIG. 1 schematically, a production line in accordance with an example embodiment;

FIG. 2 schematically, a plan view of a slicing apparatus in accordance with an example embodiment; and

FIG. 3 schematically, a side view of a conveying device operable In accordance with an example embodiment.

### REFERENCE NUMERAL LIST

11 product
13 portion
15 slicing apparatus, slicer
17 cutting plane
19 total portion
21 downstream device, packaging machine
23 packaging
25 separating layer
27 conveying device
29 conveying apparatus
31 conveyor
F conveying direction

### DETAILED DESCRIPTION

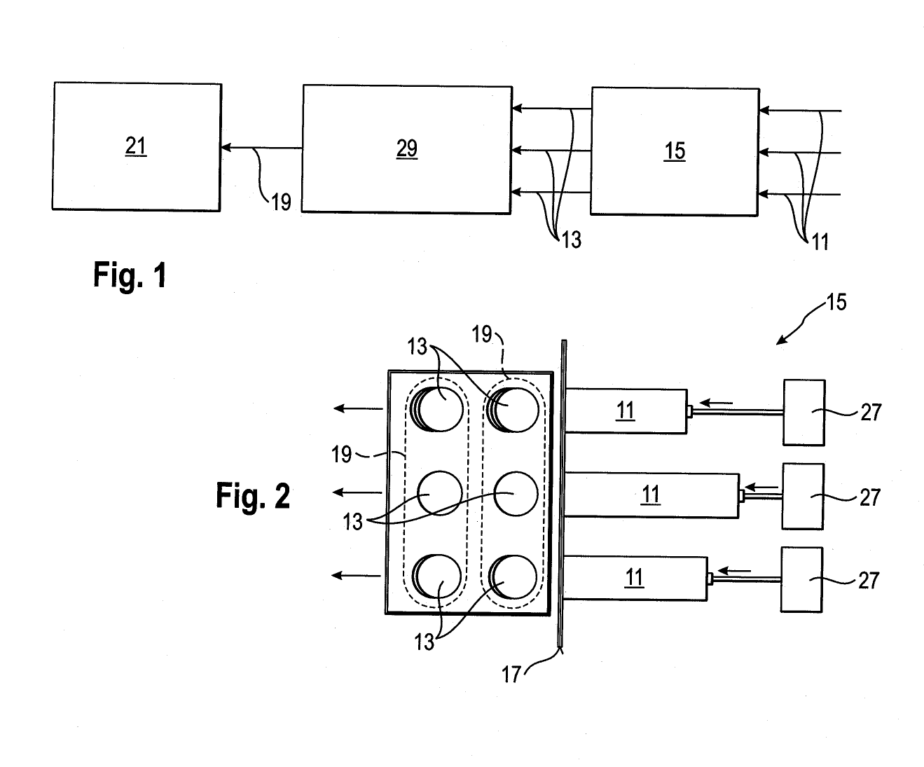

FIG. 1 first provides an overview of a possible embodiment of a production line in accordance with at least one example embodiment includes a high-performance slicer 15, a conveying apparatus 29 as well as a packaging machine 21.

The slicer 15 is able to slice a plurality of products 11—here three products—simultaneously, with one track being provided for each product 11. In at least one example embodiment, the products 11 may be food products. The slicer products portions 13 for each track during the slicing of the products 11. In accordance with the terminology used here, a portion can include one or more cut-off product slices, i.e. also a single cut-off product slice should represent a portion within the framework of example embodiments.

The conveying apparatus 29 is disposed after the slicer 15. Further, the conveying apparatus 29 provides that total portions 19 are formed from the slicer product portions 13 running in the individual tracks that are subsequently supplied to the packaging machine 21. Further, the slicer product portions 13 are packed by the packaging machine 21. Each total portion 19 thus contains a slicer product portion 13 from each of the tracks.

If the products 11 of different types are sliced by means of the slicer 15, each total portion 19 thus contains a plurality of slice types, i.e. the production line produces “mixed packages” as were already initially mentioned.

FIG. 2 diagrammatically represents a plan view of a slicing apparatus in accordance with at least one example embodiment. As is illustrated in FIG. 2, in accordance with an example embodiment, the variety of total portions that can be produced can be further increased, i.e. the portions 13 simultaneously produced by the multitrack slicing cannot differ from one another with respect to the type of the product slices forming the portions 13.

The three products 11 can be supplied individually to the cutting plane 17 of the slicer 15, in which at least one cutting blade, not shown here, moves. In the example shown here, a conveying device 27, which engages at the rear product end and supplies the product 11 in the direction of the arrow to the cutting plane 17, is provided for each track and thus for each product 11 to be sliced. The individual product supply means that the supply speed in each track and thus for each product 11 can be set and varied individually.

It is in particular possible in each track to interrupt the product supply temporarily, i.e. to stop the respective conveying device 27 to carry out so-called blank cuts with respect to the respective product, i.e. to achieve that no slices are temporarily cut from the respective product 11, as was already mentioned in the introduction part.

It is hereby not only possible due to the individual product supply to predefine as desired e.g. the weight and/or thickness of the product slices forming the respective portion 13 or the portion weight on an individual track basis, but it is also possible individually to select in the individual tracks the number of the respective product slices forming the portions 13 for each track.

The latter is indicated in FIG. 2. The portions 13 formed from the simultaneously sliced products 11 respectively have two slices in the left track, respectively one slice in the middle track and respectively three slices in the right track. This result can be achieved in that a slice is cut off from the right product in each cutting procedure for the respective cutting movements or cutting procedures of the cutting blade following one another, whereas two blank cuts are carried out with the middle product and one blank cut with the left product. The right product is therefore sliced “the fastest”, whereas the middle product is sliced “the slowest”, which is indicated in FIG. 2 by the correspondingly different residual product lengths.

The respective three portions 13 disposed next to one another in the tracks are led together to form a total portion 19 by downstream processes, as is indicated by dashed lines in FIG. 2.

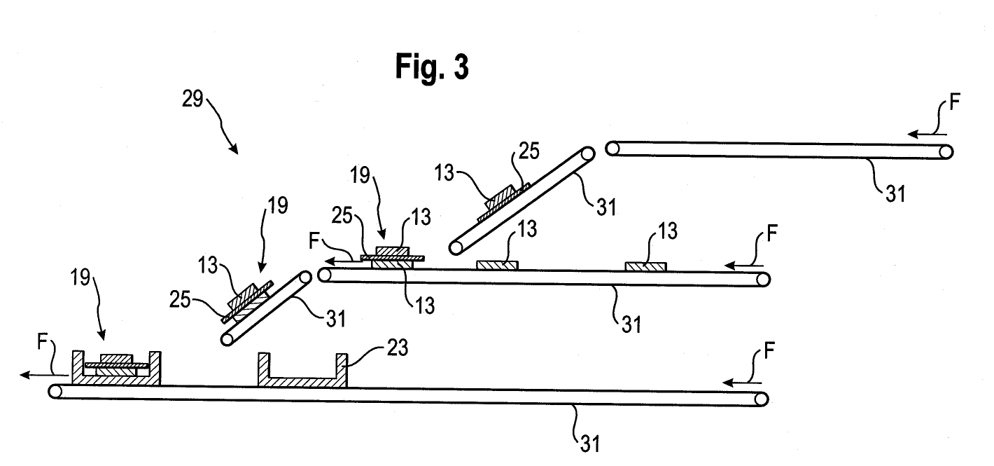

FIG. 3 diagrammatically represents a side view of a conveying device 29 operable In accordance with at least one example embodiment. In FIG. 3, a possibility is illustrated for the example of a two-track operation for forming total portions 19 from two respective portions 13 also called individual portions in the following. The individual portions 13 can each comprise one or more product slices which are not shown individually here.

The conveying apparatus 29 illustrated in FIG. 3 may also be called a stacking device since the individual portions 13 are each stacked above one another in the forming of the total portions 19.

The transport of the individual portions 13, of the total portions 19 as well as of packages 23 taking place in a conveying direction F, which will be looked at in more detail in the following, is provided in the example shown here by conveyors 31 which are formed as continuous belt conveying devices.

An upper portion 13 is already disposed on a separating layer 25 comprising paper, for example. The placing of the upper portions 13 onto the separating layers 25 takes place at an upstream point, not shown. The respective upper portions 13 disposed on the separating layer 25 move by means of a downwardly inclined conveying belt 31 facing in the direction of a middle conveying belt 31 to a lower portion 13, whereby a total portion 19 is created which is in turn placed by means of a downwardly inclined conveying belt 33 into packages 23 transported in via a lower conveying belt 31.

The conveying belt 31 transporting in the packages 23 can be considered as a component of the packaging machine that is not otherwise shown here, and in which the packages 23 provided with the total portions 19 are completed, in particular closed.

The upper portion 13 and the lower portion 13 originate from different tracks of a slicing apparatus, as was explained above for the example of FIG. 2. The upper portion 13 can, for example, be three slices of cheese, whereas the lower portion 13 is, for instance, formed by two slices of ham, with the bottommost slice of cheese being separated from the topmost slice of sausage by the separating layer 25.

Furthermore, the upper portion 13 and the lower portion 13 can differ from one another with respect to their total weight, with respect to the weight of their slices or with respect to the thickness of their slices. These parameters can be set in generally in any desired manner by a corresponding control of the product supply of the slicer 15, as was described above.

What is claimed is:

1. A method for the simultaneous multitrack slicing of a plurality of products into respective portions including at least one product slice, the method comprising:
slicing the plurality of products using a common slicing apparatus which has at least one cutting blade, at least one of which rotates about a blade axis in a cutting plane and revolves about a center axis in a planetary motion manner; and
supplying the plurality of products to the at least one cutting blade individually such that each portion satisfies a condition for a respective track of the multitrack.

2. A method in accordance with claim 1, wherein the condition relates to at least one of a weight of the portion, a weight of product slices forming the portion, a thickness of the product slices forming the portion, and a number of the product slices forming the portion.

3. A method in accordance with claim 1, wherein the plurality of products are individually supplied to the cutting blade individually of one another in the multitrack.

4. A method in accordance with claim 1, wherein the plurality of products are supplied to the cutting blade in the respective track such that a plurality of conveying devices, which are arranged in parallel next to one another, are driven together and individual speeds of the plurality of conveying devices are individually varied.

5. A method of forming total portions from a plurality of portions which each includes at least one slice of a product, with the plurality of portions having been produced by simultaneous multitrack slicing of a plurality of the products into respective portions including the at least one product slice, the method comprising:
slicing the plurality of products using a common slicing apparatus which has at least one cutting blade, at least one of which rotates about a blade axis in a cutting plane and revolves about a center axis in a planetary motion manner; and
supplying the plurality of products to the cutting blade individually such that each of the plurality of portions satisfies a condition for a respective track of the multitrack.

6. A method in accordance with claim 5, wherein the portions are disposed at least partly above one another.

7. A method in accordance with claim 5, wherein the total portions are formed from the plurality of portions whose slices differ from one another with respect to the product type.

8. A method in accordance with claim 5, wherein the total portions are formed from the plurality of portions which differ from one another with respect to at least one of a number of slices of the portions, portion weights, and a weight and thickness of the slices.

9. A method in accordance with claim 8, wherein the total portions are formed during transport of the plurality of portions to a downstream device.

10. A method in accordance with claim 9, wherein the downstream device is a packaging machine for the total portions.

11. A method in accordance with claim 8, wherein the total portions are formed by placing the plurality of portions at least partly above one another.

12. A method in accordance with claim 8, wherein the total portions are formed by introducing the plurality of portions into a package after one another.

13. A method in accordance with claim 11, wherein the plurality of portions are introduced into a package after one another during transport of the plurality of portions to a downstream device.

14. A method in accordance with claim 8, wherein a separating layer is placed between at least two respective portions disposed at least partly above one another on the formation of the total portions.

15. A method in accordance with claim 7, wherein a separating layer is placed between at least two respective ones of the plurality of portions disposed at least partly above one another on the formation of the total portions.

16. An apparatus for simultaneous multitrack slicing of a plurality of products into respective portions including at least one product slice, the apparatus including:
a product feed which includes a plurality of conveying devices, the conveying devices being arranged in parallel next to one another and configured to supply the products in multitracks to a cutting plane in which at least one cutting blade is moved;
wherein the product feed is configured to supply the products to the cutting blade individually such that each portion satisfies a condition for a respective track of the multitrack.

17. An apparatus in accordance with claim 16, wherein each of the conveying devices of the product feed are capable of being operated completely independently of one another.

18. An apparatus in accordance with claim 16, wherein the conveying devices are capable of being driven together and individual speeds of the conveying devices are individually variable.

19. A product line comprising:
at least one slicing apparatus configured for simultaneous multitrack slicing of a plurality of products into respective portions including at least one product slice,
a product feed which includes a plurality of conveying devices, the plurality of conveying devices being arranged in parallel next to one another and configured to supply the products in multitracks to a cutting plane in which at least one cutting blade is moved;
wherein the product feed is configured to supply the products to the cutting blade individually such that each portion satisfies a condition for a respective track of the multitrack; and
at least one conveying apparatus configured to form total portions from the portions from the plurality of portions which each include at least one slice of the product,
wherein the portions have been produced by slicing a plurality of the products into respective portions including the at least one product slice,
wherein the products are sliced using a common slicing apparatus which has the at least one cutting blade which at least one of rotates about a blade axis in the cutting plane and revolves about a center axis in a planetary motion manner.

20. A production line in accordance with claim 19, wherein at least one packaging machine for the total portions is disposed downstream of the at least one conveying apparatus.
